(19) United States
(12) Patent Application Publication
(10) Pub. No.: US 2010/0025139 A1
(43) Pub. Date: Feb. 4, 2010

(54) VEHICLE BODY STRUCTURE AND COAXIAL TWO-WHEEL VEHICLE

(75) Inventors: Yusuke Kosaka, Tokyo-to (JP); Susumu Oikawa, Yokohama-shi (JP); Takekazu Kakinuma, Tokyo-to (JP); Ikuo Yamano, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/533,755

(22) Filed: Jul. 31, 2009

(30) Foreign Application Priority Data
Jul. 31, 2008 (JP) 2008-197816

(51) Int. Cl. B62D 61/02; B62D 33/00

(52) U.S. Cl. 180/218; 296/203.01

(57) ABSTRACT

Provided is a vehicle body which constitutes a coaxial two-wheel vehicle including two wheels coaxially arranged. The vehicle body includes: a parallel linkage that includes horizontal links and vertical links and is rotatable in a left-and-right direction of the coaxial two-wheel vehicle; and step plates respectively provided to upper end portions of the vertical links. A load of a passenger riding on the left and right step plates acts on the parallel linkage at a position inside or outside of a line which passes through a ground contact point of one of the wheels respectively mounted to the vertical links and which is in parallel with the vertical links.

### BACKGROUND OF THE INVENTION

1. Field of the Invention

The present invention relates to a vehicle body structure and a coaxial two-wheel vehicle having the vehicle body structure.

2. Description of Related Art

In coaxial two-wheel vehicles, two wheels which are coaxially arranged are drivingly mounted to a vehicle body. In each coaxial two-wheel vehicle, the rotational speed of left and right wheels is changed in accordance with an operation of a passenger, to thereby achieve a turning operation.

In a coaxial two-wheel vehicle disclosed in Japanese Patent No. 3981733, for example, a boarding platform of a vehicle body is supported in a seesaw manner so as to be tilted in a left-and-right direction. The coaxial two-wheel vehicle detects tilting of the boarding platform using a sensor, and changes the rotational speed of the left and right wheels based on detection signals from the sensor, thereby achieving a turning operation.

In a coaxial two-wheel vehicle disclosed in Japanese Unexamined Patent Application Publication No. 2006-315666, a vehicle body composed of a parallel linkage is disposed so as to be rotatable in the left-and-right direction of the coaxial two-wheel vehicle. Step plates on which a passenger rides are provided to upper ends of vertical links of the vehicle body. In the coaxial two-wheel vehicle, when the passenger riding on the step plates causes a turning operation portion, which is coupled to the vehicle body, to be tilted, the turning operation portion is tilted and opposite links of the vehicle body rotate while maintaining a parallel state. In this case, vertically-arranged horizontal links of the vehicle body are horizontally disposed. The coaxial two-wheel vehicle detects a tilt angle of the turning operation portion with respect to the vertically-arranged horizontal links by using a sensor, and changes the rotational speed of left and right wheels based on detection signals from the sensor, thereby achieving a turning operation.

Incidentally, there is an increasing demand not only for a mobility performance but also for an entertainment performance that allows a passenger to enjoy the operation of a coaxial two-wheel vehicle in an integrated manner, by actively changing distribution of a load, as in the case of skiing and surfing.

In the coaxial two-wheel vehicle disclosed in Japanese Patent No. 3981733, the boarding platform is tilted while the passenger actively changes the distribution of the load. In the coaxial two-wheel vehicle, however, the vehicle body does not rotate in a turning direction integrally with the passenger. Accordingly, the coaxial two-wheel vehicle has not achieved the performance that allows a passenger to enjoy the operation of the coaxial two-wheel vehicle in an integrated mariner.

The coaxial two-wheel vehicle disclosed in Japanese Unexamined Patent Application Publication No. 2006-315666 has substantially the same structure as that of a vehicle body according to an embodiment of the present invention. In the coaxial two-wheel vehicle, however, the turning operation portion coupled to the vehicle body is operated by a passenger, to thereby achieve a turning operation. Thus, the coaxial two-wheel vehicle has not achieved the performance that allows a passenger to enjoy the operation of the coaxial two-wheel vehicle in an integrated manner.

It is therefore an object of the present invention to provide a vehicle body structure having an entertainment performance that allows a passenger to enjoy an operation of a coaxial two-wheel vehicle in an integrated manner, by actively changing the distribution of a load, and a coaxial two-wheel vehicle having the vehicle body structure.

### SUMMARY OF THE INVENTION

According to an aspect of the present invention, there is provided a vehicle body structure which constitutes a coaxial two-wheel vehicle including two wheels coaxially arranged, the vehicle body including: a parallel linkage that includes horizontal links and vertical links and is rotatable in a left-and-right direction of the coaxial two-wheel vehicle; and step plates respectively provided to upper end portions of the vertical links. In the vehicle body structure, a load of a passenger riding on the left and right step plates acts on the parallel linkage at a position inside or outside of a line which passes through a ground contact point of one of the wheels respectively mounted to the vertical links and which is in parallel with the vertical links, during a turning operation of the coaxial two-wheel vehicle. With this structure, when the passenger depresses one of the step plates with the foot at the outside or inside of a turning direction to actively change distribution of the load, the parallel linkage and the step plates, which constitute the vehicle body, and the wheels are tilted in the turning direction in conjunction with each other. Therefore, the passenger can enjoy the operation of the coaxial two-wheel vehicle integrally with the coaxial two-wheel vehicle.

An areas of each of the step plates inside of the line which passes through the ground contact point of one of the wheels and which is in parallel with the vertical links may preferably serve as a footrest portion. Further, the load of the passenger riding on the footrest portion of each of the left and right step plates may preferably act on the parallel linkage at a position inside or outside of a line which passes through the ground contact point of one of the wheels and which is in parallel with the vertical links, during the turning operation of the coaxial two-wheel vehicle. With this structure, the passenger can depress one of the step plates with the foot at the outside of the turning direction during the turning operation, and can be brought into a state capable of easily withstanding the centrifugal force during the turning operation.

The step plates may preferably project outward from the ground contact points of the wheels respectively, and a projecting portion of each of the step plates may preferably serve as a footrest portion. Further, the load of the passenger riding on the footrest portion of each of the step plates may preferably act on the parallel linkage at a position outside of the line which passes through the ground contact point of one of the wheels and which is in parallel with the vertical links, during the turning operation of the coaxial two-wheel vehicle. This structure enables the passenger to operate the vehicle in a posture similar to so-called “lean in” and also enables the passenger to enjoy a better operational feeling of the coaxial two-wheel vehicle.

The step plates may preferably be provided to the vertical links, respectively, through variable portions that allow the step plates to be slid in the left-and-right direction of the coaxial two-wheel vehicle.

The variable portions may preferably be actively controlled based on the distribution of the load of the passenger to the left and right step plates. With this structure, the turning operation can be triggered by the foot at the inside of the turning direction. This enables the passenger to facilitate intuitive understanding of the turning operation of the coaxial two-wheel vehicle and to easily learn how to operate the coaxial two-wheel vehicle. Moreover, the passenger can depress one of the step plates also with the foot at the outside of the turning direction during the turning operation, and thus can easily withstand the centrifugal force.

The variable portions may be actively controlled based on a rotation angle of the vehicle body. This structure enables the passenger to apply approximately the same load to the left and right step plates.

According to another aspect of the present invention, there is provided a coaxial two-wheel vehicle including two wheels coaxially arranged, and the vehicle body structure as described above. With this structure, when the passenger depresses one of the step plates with the foot at the outside or inside of a turning direction to actively change the distribution of the load, the parallel linkage and the step plates, which constitute the vehicle body, and the wheels are tilted in the turning direction in conjunction with each other. Therefore, the passenger can enjoy the operation of the coaxial two-wheel vehicle integrally with the coaxial two-wheel vehicle.

According to an embodiment of the present invention, it is possible to provide a vehicle body structure having an entertainment performance that allows a passenger to enjoy an operation of a coaxial two-wheel vehicle in an integrated manner, by actively changing distribution of a load, and a coaxial two-wheel vehicle having the vehicle body structure.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a perspective view schematically showing a coaxial two-wheel vehicle according to a first embodiment of the present invention;

FIG. 2 is a front view showing a vehicle body structure according to the first embodiment of the present invention;

FIG. 3 is a schematic view showing dynamic characteristics of the vehicle body structure according to the first embodiment of the present invention when the vehicle body structure is balanced;

FIG. 4 is a schematic view schematically showing a turning operation of the vehicle body structure according to the first embodiment of the present invention;

FIG. 5 is a schematic view showing dynamic characteristics of the vehicle body structure according to the first embodiment of the present invention during the turning operation;

FIG. 6 is a block diagram showing the schematic structure of a control system of the coaxial two-wheel vehicle according to the first embodiment of the present invention;

FIG. 7 is a schematic view showing dynamic characteristics of a vehicle body structure according to a second embodiment of the present invention when the vehicle body structure is balanced;

FIG. 8 is a schematic view schematically showing a turning operation of the vehicle body structure according to the second embodiment of the present invention;

FIG. 9 is a schematic view showing dynamic characteristics of the vehicle body structure according to the second embodiment of the present invention during the turning operation;

FIG. 10 is a schematic view showing dynamic characteristics of a vehicle body structure according to a third embodiment of the present invention when the vehicle body structure is balanced;

FIG. 11 is a schematic view showing dynamic characteristics of the vehicle body structure according to the third embodiment of the present invention during the turning operation;

FIG. 12 is a schematic diagram showing dynamic characteristics of a vehicle body structure according to a fourth embodiment of the present invention during a turning operation; and

FIG. 13 is a block diagram showing the schematic structure of a control system of a coaxial two-wheel vehicle according to the fourth embodiment of the present invention.

### DESCRIPTION OF THE PREFERRED EMBODIMENTS

Embodiments of a vehicle body structure and a coaxial two-wheel vehicle according to the present invention will be described in detail below with reference to the accompanying drawings. It should be noted, however, that the present invention is not limited to the embodiments described below. Additionally, the following description and drawings are simplified as appropriate for clarification of the explanation.

### First Embodiment

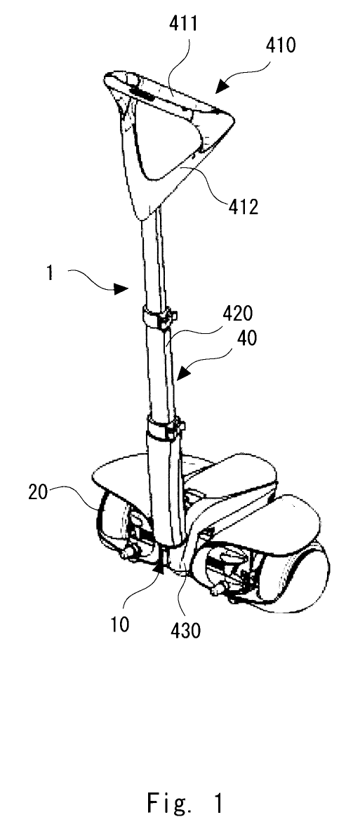

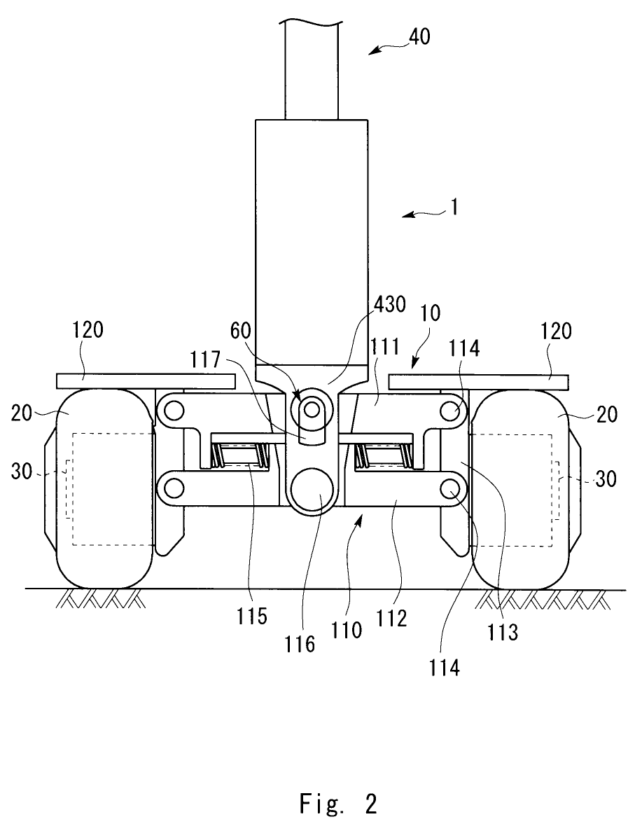

As shown in FIGS. 1 and 2, a coaxial two-wheel vehicle 1 according to a first embodiment of the present invention includes a vehicle body 10, wheels 20, wheel drive devices 30, and a support member 40.

As shown in FIG. 2, the vehicle body 10 includes a parallel linkage 110 and step plates 120. The parallel linkage 110 includes horizontal links 111 and 112 and vertical links 113.

The horizontal links 111 are upper link members of the parallel linkage 110. Two horizontal links 111 are disposed in the back-and-forth direction of the vehicle body 10. Each of the horizontal links 111 has a bearing hole which is formed at an intermediate portion thereof in the longitudinal direction so as to penetrate the vehicle body 10 in the back-and-forth direction. Further, each of the horizontal links 111 has bearing holes which are formed in the left and right end portions so as to penetrate the vehicle body 10 in the back-and-forth direction. The two horizontal links 111 are disposed such that the end portions of the two horizontal links 111 sandwich the upper end portions of the vertical links 113.

The horizontal links 112 are lower link members of the parallel linkage 110. Two horizontal links 112 are disposed in the back-and-forth direction of the vehicle body 10. Each of the horizontal links 112 has the same structure as that of each of the horizontal links 111. The two horizontal links 112 are disposed such that the end portions of the two horizontal links 112 sandwich the lower end portions of the vertical links 113.

The vertical links 113 are left and right link members of the parallel linkage 110. Two vertical links 113 are disposed on the left and right sides of the parallel linkage 110. Each of the vertical links 113 is formed of a flat plate-shaped member. Each of the vertical links 113 has bearing holes in upper and lower end portions thereof so as to penetrate the vehicle body 10 in the back-and-forth direction. The vertical links 113 are respectively disposed at both end portions between the two horizontal links 111, 111 and the two horizontal links 112, 112 which are vertically arranged. Further, the bearing holes of the vertical links 113 are arranged coaxially with the bearing holes of the horizontal links 111 and 112. Turning support pins 114 are respectively inserted into the bearing holes so as to penetrate therethrough. Thus, the horizontal links 111 and 112 and the vertical links 113 constitute the parallel linkage that is rotatable in the left-and-right direction of the coaxial two-wheel vehicle 1. The horizontal links 111 and 112 are coupled together with restoring members 115 such as springs. The restoring members 115 are restored from the state in which the parallel linkage 110 is rotated in the left-and-right direction of the coaxial two-wheel vehicle 1, to the original state. That is, the restoring members 115 are restored from the shape of a parallelogram in which the vertical links 113 are inclined, to the shape of a right-angled quadrangle.

The wheel drive devices 30 are respectively mounted to the outer surfaces of the vertical links 113. Each of the wheel drive devices 30 can be composed of an electric motor, a decelerate gear train connected to a rotating shaft of the electric motor in a power transmitting manner, and the like. The wheel drive devices 30 each include a fixation portion that is fixed to each of the vertical links 113, and a rotation portion that is rotatably supported by the fixation portion. The wheels 20 are respectively mounted to the rotation portions. When the wheels 20, which are respectively supported by the vertical links 113 through the wheel drive devices 30 in the manner as described above, are located on an even road surface, the rotation centers of the wheels 20 are coaxially aligned.

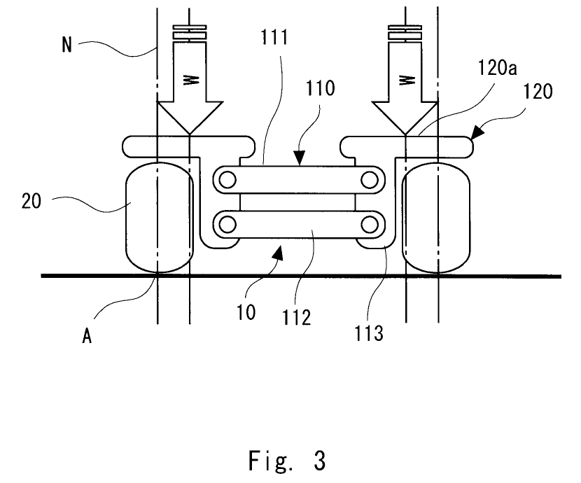

Further, upper end portions of the vertical links 113 project upward from the upper surfaces of the horizontal links 111. The step plates 120 are horizontally mounted to the upper end surfaces of the vertical links 113, respectively. Specifically, referring to FIG. 3, the left and right step plates 120 are respectively provided to the upper end portions of the vertical links 113. When both feet of the passenger are placed on the left and right step plates 120, respectively, the load of the passenger acts on the parallel linkage 110 at a position inside of a line N which passes through a ground contact point A of one of the wheels 20 and which is in parallel with the vertical links 113. In this embodiment, an areas of each of the left and right step plates 120 inside of the line N serves as a footrest portion 120a. As a result, the load of the passenger riding on the footrest portions 120a of the left and right step plates 120 acts on the parallel linkage 110 at a position inside of the line N. Note that the interval between the left and right step plates 120 is set to be equal to a distance between both feet of a person who is standing in a natural state.

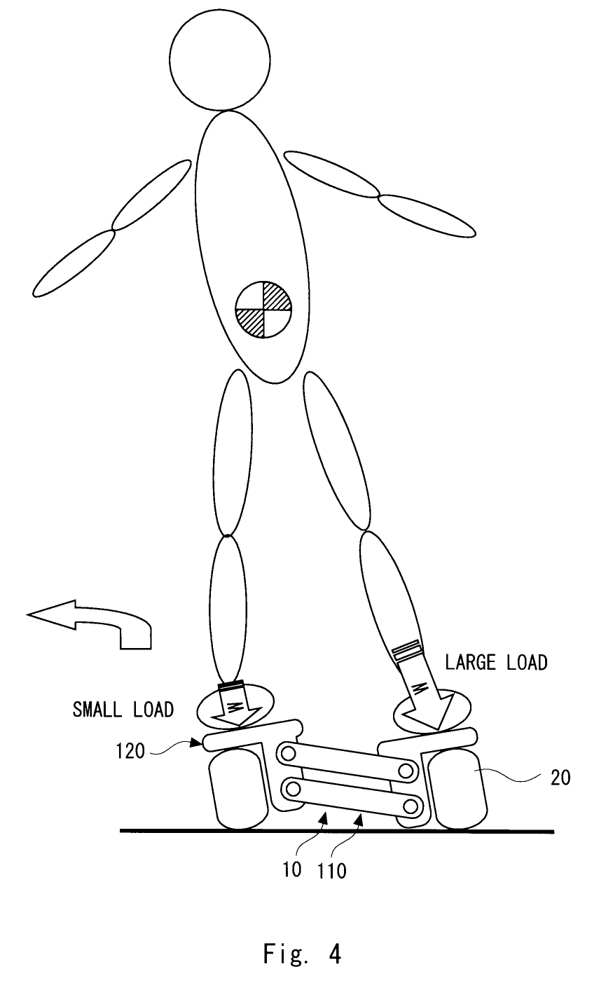

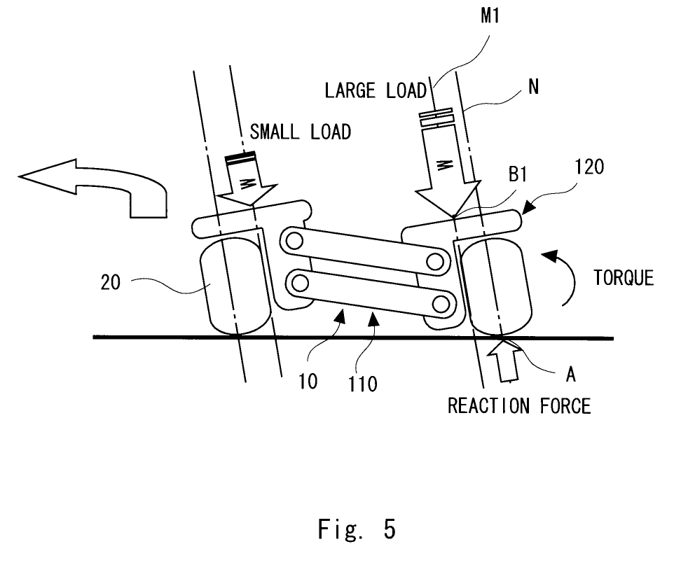

Referring to FIG. 3, the parallel linkage 110 as described above remains balanced when the passenger applies approximately the same load to the footrest portions 120a of the left and right step plates 120. Meanwhile, referring to FIGS. 4 and 5, when the passenger depresses the step plate 120 with the foot at the outside of the turning direction to apply a large load W to the step plate 120 which is depressed with the foot, a torque in the turning direction is generated in the parallel linkage 110. That is, the load W acts downward. At the ground contact point A of the wheel 20 located on the outside of a line M1 which passes through a point of application B1 of the load W and which is in parallel with the vertical link 113, a reaction force against the load W acts upward. Thus, the torque in the turning direction is generated. Therefore, the parallel linkage 110 is structured to rotate in the turning direction when the passenger depresses one of the step plates with the foot at the outside of the turning direction. In this case, the step plates 120 and the wheels 20 are also tilted in the turning direction in conjunction with the rotation of the parallel linkage 110.

The support member 40 includes a handle 410, a handle bar 420, and a handle bar bracket 430.

The handle 410 includes a grip portion 411 having an annular shape in plan view, and a support portion 412 for supporting the grip portion 411 from the back side. The passenger grips the grip portion 411 to stabilize the posture of the passenger at the time of traveling and getting on/off the vehicle. If transport wheels are provided to the rear side surfaces of the vertical links 113 of the vehicle body 10, the coaxial two-wheel vehicle 1 can be transported while being pulled. Specifically, the coaxial two-wheel vehicle is transported while being pulled in the state where the passenger grips the grip portion 411 to tilt the coaxial two-wheel vehicle 1 backward and the coaxial two-wheel vehicle 1 is supported by the transport wheels. A lower end portion of the support portion 412 is connected to the handle bar 420. A lower end portion of the handle bar 420 is connected to an upper end portion of the handle bar bracket 430.

The handle bar bracket 430 is formed in a shape that straddles the vehicle body 10 at the center position thereof in the back-and-forth direction. At a front portion of the handle bar bracket 430, a front surface portion extending to a lower portion of the vehicle body 10 is formed. The front surface portion has a bearing hole which is formed at a position corresponding to a bearing hole formed at a middle portion of each of the horizontal links 111 and 112 that are vertically arranged at the front of the vertical links 113. The bearing hole formed at the middle portion of each of the horizontal links 111 and 112 and the bearing hole formed in the front surface portion are coaxially arranged. A rotation support shaft 116 is inserted into the bearing holes to penetrate therethrough.

At a rear portion of the handle bar bracket 430, a rear surface portion (not shown) extending to the lower portion of the vehicle body 10 is formed. The rear surface portion has a bearing hole which is formed at a position corresponding to a bearing hole formed at a middle portion of each of the horizontal links 111 and 112 that are vertically arranged at the rear of the vertical links 113. The bearing hole formed at the middle portion of each of the horizontal links 111 and 112 and the bearing hole formed in the rear surface portion are coaxially arranged. The rotation support shaft is inserted into the bearing holes to penetrate therethrough. In this case, the bearing holes formed at the front and rear portions of the handle bar bracket 430 are coaxially arranged.

When the parallel linkage 110 rotates in the turning direction, the support member 40 as described above rotates in conjunction with the rotation of the parallel linkage 110. In other words, the support member 40 remains in parallel with the vertical links 113 of the parallel linkage 110.

In order to detect a rotation angle (tilt angle) of the support member 40, the rotation support shaft 116 is provided with an angle detection sensor 60. The angle detection sensor 60 includes an axle portion fixed to the rotation support shaft 116, and a detection portion for detecting an amount of relative rotational displacement from the axle portion. The detection portion is fixed to one end of a fixing plate 117. The other end of the fixing plate 117 is fixed to the front surface portion of the handle bar bracket 430.

A potentiometer, a sensor having a variable capacitor structure, or the like can be applied as the angle detection sensor 60, for example. The angle detection sensor 60 detects a tilt angle of the handle bar bracket 430 with respect to the parallel linkage 110. In this case, the angle detection sensor 60 utilizes a change in resistance value that occurs in accordance with the rotational displacement amount generated between the axle portion and the detection portion.

The coaxial two-wheel vehicle 1 shown in FIG. 1 has a storage portion formed therein. The storage portion is formed in a gap between the front and rear horizontal links 111, 111 and the front and rear horizontal links 112, 112, within a space between the left and right step plates 120 and 120. The storage portion accommodates a battery 61 that is a specific example of a power supply for supplying electric power to the left and right wheel drive devices 30, the control device, the other electronic devices, and the like. The storage portion also accommodates drive circuits 64 (64L, 64R), a posture detection sensor unit 62, and a control device 63. The drive circuits 64 (64L, 64R) drive the left and right wheel drive devices 30, respectively, for example. The posture detection sensor unit 62 is posture detection means that detects the posture of the coaxial two-wheel vehicle 1 and outputs detection signals. The control device 63 outputs control signals for driving and controlling the left and right wheel drive devices 30 and the like. A heavy load such as the battery 61 is concentrically accommodated at a position immediately below the passenger riding on the left and right step plates 120. This contributes to mass centralization and improvement in operability of the coaxial two-wheel vehicle.

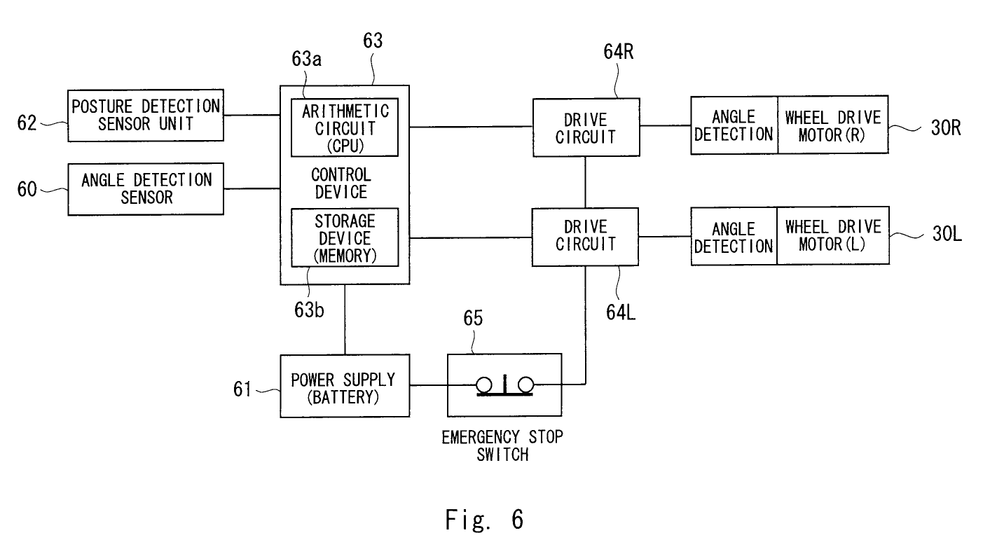

The control device 63 executes predetermined arithmetic processing based on the detection signals from the posture detection sensor unit 62, detection signals from the angle detection sensor 60, and the like, and outputs necessary control signals to the left and right wheel drive devices 30 and the like. As shown in FIG. 6, the control device 63 includes an arithmetic circuit 63a and a storage device 63b. The arithmetic circuit 63a includes a microcomputer (CPU), for example. The storage device 63b includes a program memory, a data memory, and other memories such as a RAM and a ROM, for example. The battery 61 and the left and right drive circuits 64 (64L, 64R) are each connected to the control device 63. The battery 61 and the left and right drive circuits 64 (64L, 64R) are also connected to each other through an emergency stop switch 65. The left and right drive circuits 64L and 64R individually control a rotational speed, a rotational direction, and the like of the left and right wheels 20. The left and right drive circuits 64L and 64R are individually connected to the left and right wheel drive devices 30 (30L, 30R).

The control device 63 receives the detection signals from the angle detection sensor 60 that detects the tilt angle of the support member, and the detection signals from the posture detection sensor unit 62. The posture detection sensor unit 62 is used for detecting an angular velocity and an acceleration of the coaxial two-wheel vehicle 1 during traveling, to thereby control the angular velocity and acceleration. The posture detection sensor unit 62 is composed of, for example, a gyroscopic sensor and an acceleration sensor.

The passenger riding on the left and right step plates 120 depresses one of the step plates 120 with the foot at the outside of the turning direction, thereby applying a load to the step plate 120. As a result, the opposite links of the parallel linkage 110 rotate in the turning direction while maintaining their parallel state, and the support member 40 also rotates in the tuning direction in conjunction with the rotation of the links. In this case, upon detection of the tilt angle of the support member 40 with respect to the horizontal links 111 and 112 that are horizontally disposed, the angle detection sensor 60 outputs detection signals to the control device 63. The control device 63 receiving the detection signals performs predetermined arithmetic processing based on the detection signals. Then, the control device 63 calculates a deceleration of the rotational speed of the wheel at the inside of the turning direction, or an acceleration of the rotational speed of the wheel at the outside of the turning direction. Further, the control device 63 outputs signals indicating the calculation results to each of the wheel drive devices 30. The wheel drive devices 30 receiving the signals indicating the calculation results control the rotational speeds of the motors based on the signals indicating the calculation results, to thereby drive the wheels 20. Thus, when the passenger depresses one of the step plates with the foot at the outside of the turning direction to actively change the load distribution, the parallel linkage 110 and the step plates 120, which constitute the vehicle body 10, and the wheels 20 are tilted in the turning direction in conjunction with each other. Therefore, the passenger can enjoy the operation of the coaxial two-wheel vehicle 1 integrally with the coaxial two-wheel vehicle 1. Additionally, the passenger can be brought into a state capable of easily withstanding the centrifugal force during the turning operation.

Further, the passenger riding on the left and right step plates 120 moves the load of the passenger forward or backward, to thereby rotate the coaxial two-wheel vehicle 1 in the back-and-forth direction. Thus, the posture detection sensor unit 62 detects the angular velocity and acceleration of the coaxial two-wheel vehicle 1, and outputs detection signals to the control device 63. The control device 63 receiving the detection signals performs predetermined arithmetic processing based on the detection signals, and calculates a drive torque required for stabilizing the coaxial two-wheel vehicle 1 so as to prevent overturning thereof. Then, the control device 63 outputs signals indicating the calculation results to each of the wheel drive devices. The wheel drive devices receiving the signals indicating the calculation results control the motors based on the signals indicating the calculation results, to thereby drive the wheels. In this manner, forward or backward traveling of the coaxial two-wheel vehicle 1 can be achieved in accordance with the rotation of the coaxial two-wheel vehicle 1 in the back-and-forth direction.

### Second Embodiment

A coaxial two-wheel vehicle according to a second embodiment of the present invention has substantially the same structure as that of the coaxial two-wheel vehicle of the first embodiment, except for the vehicle body structure. Note that a description of the parts common to those of the first embodiment is omitted.

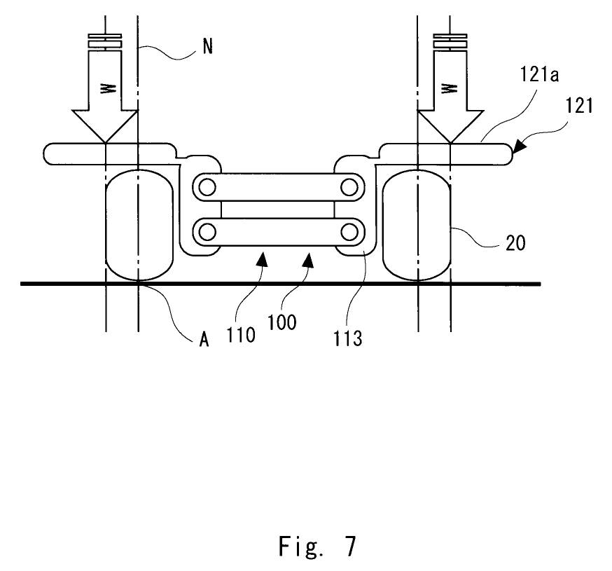

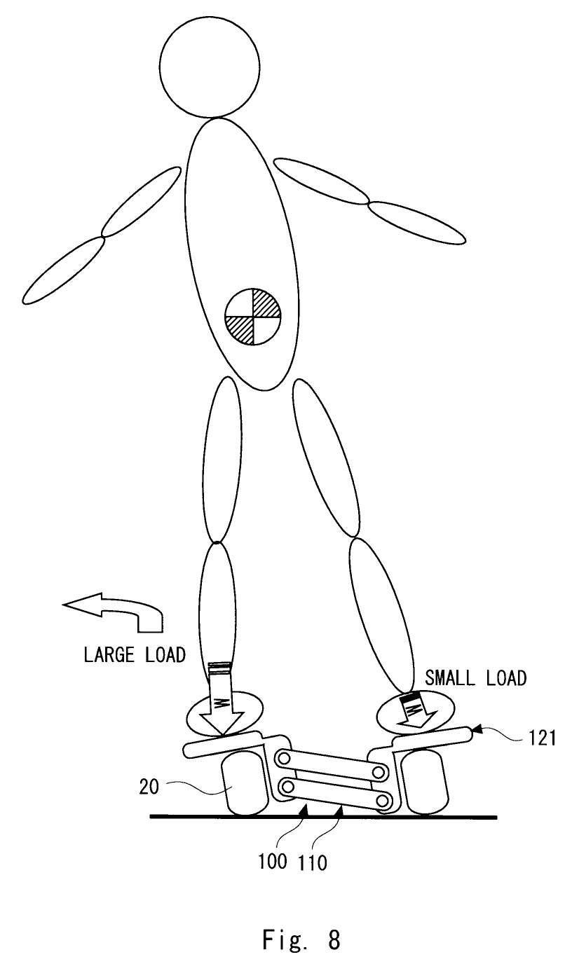

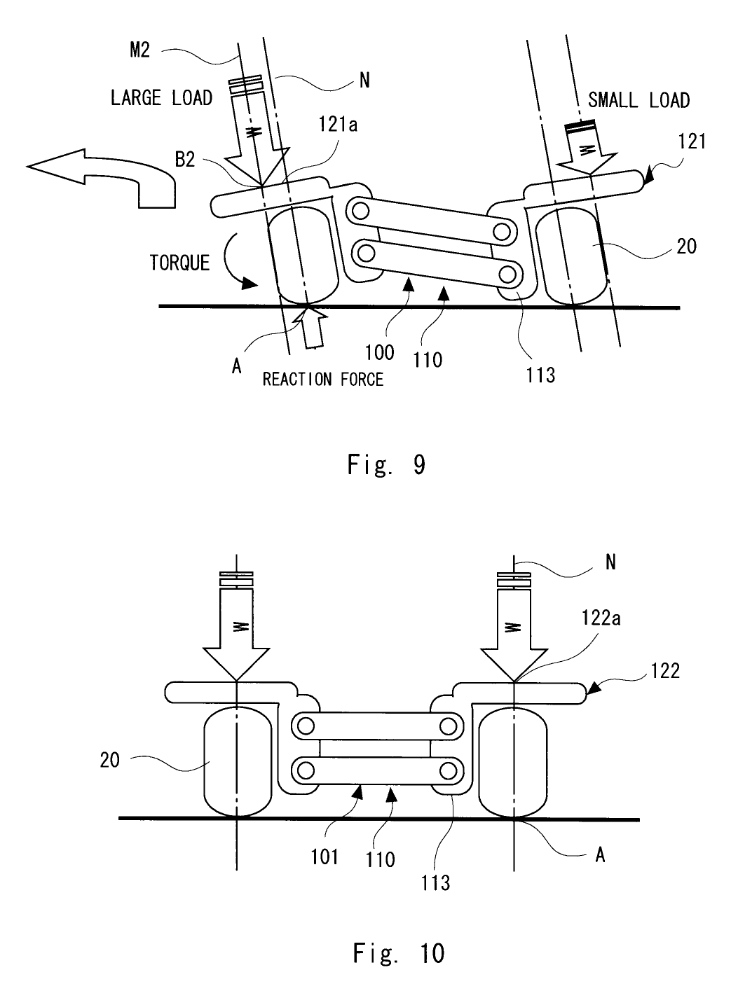

Specifically, in a vehicle body 100 of this embodiment, step plates 121 project outward from the ground contact points A of the wheels 20, respectively, as shown in FIG. 7. Projecting portions of the step plates 121 serve as footrest portions 121a. In this case, referring to FIG. 7, a passenger applies approximately the same load to the footrest portions 121a of the left and right step plates 121, thereby maintaining the balanced state. Meanwhile, referring to FIGS. 8 and 9, when the passenger depresses one of the step plates with the foot at the inside of the turning direction to apply the large load W to the step plate 121 which is depressed with the foot, a torque in the turning direction is generated in the parallel linkage 110. That is, the load W acts downward. At the ground contact point A of the wheel 20 located on the inside of a line M2 which passes through a point of application B2 of the load W and which is in parallel with the vertical links 113, a reaction force against the load W acts upward. Thus, the torque in the turning direction is generated.

Therefore, the parallel linkage 110 is structured to rotate in the turning direction when the passenger depresses one of the step plates with the foot at the inside of the turning direction. The coaxial two-wheel vehicle of the first embodiment is operated by the passenger in a posture similar to so-called “lean out”, while the coaxial two-wheel vehicle including the vehicle body 100 of this embodiment can be operated by the passenger in a posture similar to so-called “lean in”. Therefore, the passenger can enjoy a better operational feeling of the coaxial two-wheel vehicle.

### Third Embodiment

A coaxial two-wheel vehicle according to a third embodiment of the present invention has substantially the same structure as that of each of the coaxial two-wheel vehicles of the above embodiments, except for the vehicle body structure. Note that a description of the parts common to those of the above embodiments is omitted.

Specifically, in a vehicle body 101 of this embodiment, footrest portions 122a of step plates 122 are disposed on the lines N which respectively pass through the ground contact points A of the wheels 20 and which are in parallel with the vertical links 113, as shown in FIG. 10. In this case, referring to FIG. 10, the passenger applies approximately the same load to the footrest portions 122a of the left and right step plates 122, thereby maintaining the balanced state. Meanwhile, in the case of turning the coaxial two-wheel vehicle to the left, assuming that the depth direction of the plane of FIG. 11 is a traveling direction, for example, the passenger depresses the step plate with the big toe of the right foot to apply a load at a position inside of the line N. At the same time, the passenger depresses the step plate with a little toe portion of the left foot to apply a load at a position outside of the line N. This allows the coaxial two-wheel vehicle 1 to turn left. Though it is a little tough for the passenger to operate the coaxial two-wheel vehicle 1, the passenger can enjoy a better operational feeling of the coaxial two-wheel vehicle.

### Fourth Embodiment

A coaxial two-wheel vehicle according to a fourth embodiment of the present invention has substantially the same structure as that of each of the coaxial two-wheel vehicles of the above embodiments, except for the vehicle body structure. Note that a description of the parts common to those of the above embodiments is omitted.

Specifically, a vehicle body 102 of this embodiment includes load sensors 80 (80L, 80R) that are respectively provided to left and right step plates 123. Load sensors each including a typical piezoelectric element can be used as the load sensors 80.

The left and right step plates 123 are respectively provided to the vertical links 113 of the parallel linkage 110 through variable portions 82 that allow the step plates 123 to be slid in the left-and-right direction of the coaxial two-wheel vehicle 1. Although not shown in detail, each of the variable portions 82 includes a sliding mechanism and a drive device 81. Note that the structure of each of the variable portions 82 is not limited to the following structure. That is, the variable portions 82 can have any structure as long as the variable portions 82 can allow the step plates to be slid in the left-and-right direction of the coaxial two-wheel vehicle.

The sliding mechanism has a fitting piece formed on the bottom surface of a base portion. The fitting piece is fitted into a groove of a guide portion. The sliding mechanism is disposed such that the base portion and the guide portion are allowed to relatively move in the left-and-right direction of the coaxial two-wheel vehicle 1. The top surface of the base portion is connected to each step plate 123. The bottom surface of the guide portion is connected to each vertical link 113 of the parallel linkage 110.

A linear actuator can be used as the drive device 81, for example. On end of the drive device 81 is connected to the vertical link 113, and the other end thereof is connected to the step plate 123.

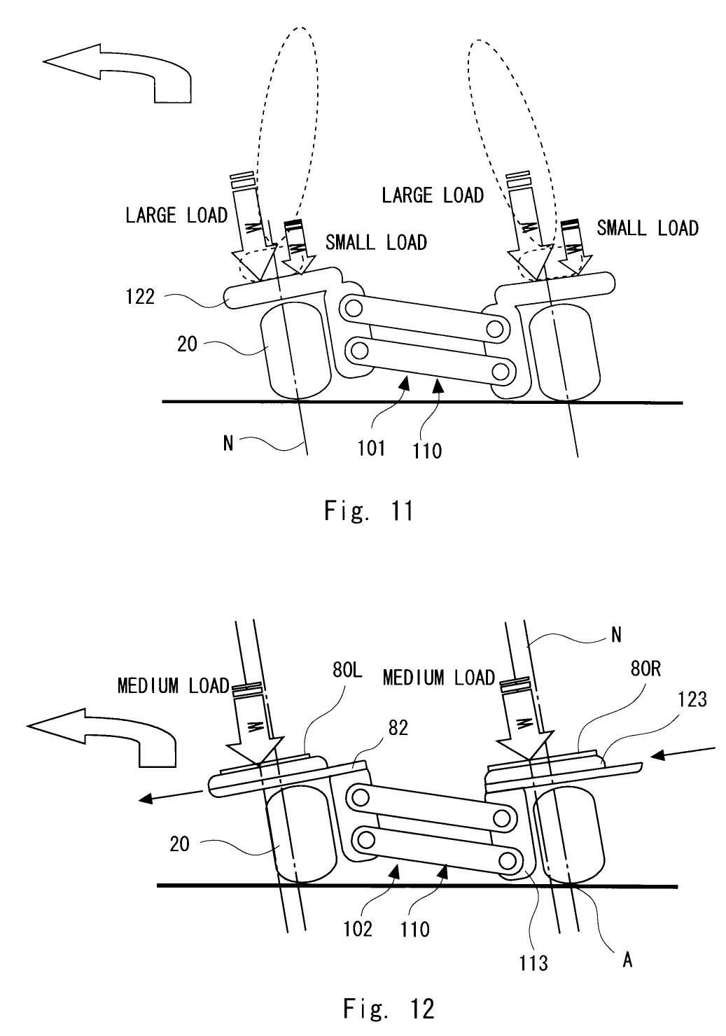

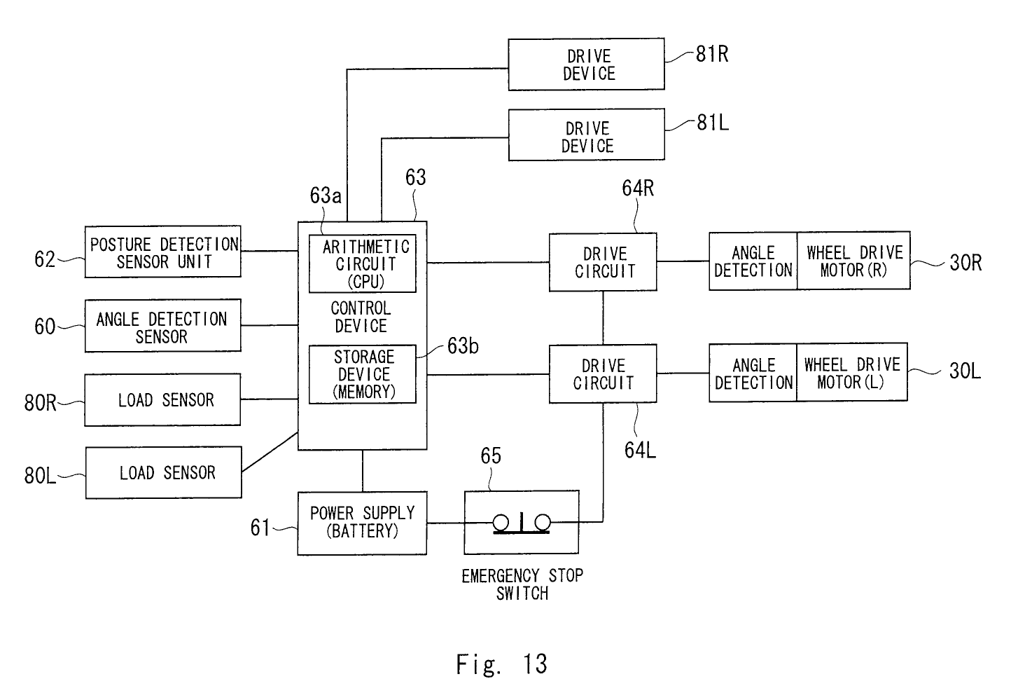

In the case of turning the vehicle body 102 having the above-mentioned structure to the left, assuming that the depth direction of the plane of FIG. 12 is a traveling direction, for example, when the passenger depresses the step plate to some extent with the left foot to apply a load to the step plate 123 at the left side, the left load sensor 80L detects an increase in load and outputs a detection signal to the control device 63 as shown in FIG. 13. The control device 63 is configured to control the drive devices 81 (81L, 81R) in the following manner. That is, when the load of one of the load sensors 80 is increased, the step plate 123 located on the side opposite to the side where the load is increased is allowed to be slid inward from the line N which passes through the ground contact point A of one of the wheels 20 and which is in parallel with the vertical links 113. Additionally, the step plate 123 located on the side where the load is increased is allowed to be slid outward from the line N. Accordingly, the control device 63 controls the drive devices 81 based on the received detection signals so that the step plate 123 at the right side is allowed to be slid inward from the line N and the step plate 123 at the left side is allowed to be slid outward from the line N. As a result, an outside portion of the vehicle body 102 in the turning direction is similar to that obtained at the time of turning the vehicle body of the first embodiment, and an inside portion of the vehicle body 102 in the turning direction is similar to that obtained at the time of turning the vehicle body of the second embodiment. Thus, the turning operation of the coaxial two-wheel vehicle 1 is achieved. In this manner, the turning operation can be triggered by the foot at the inside of the turning direction. This enables the passenger to facilitate intuitive understanding of the turning operation of the coaxial two-wheel vehicle and to easily learn how to operate the coaxial two-wheel vehicle. Moreover, the passenger can depress one of the step plates also with the foot at the outside of the turning direction during the turning operation, and thus can easily withstand the centrifugal force.

### Fifth Embodiment

A coaxial two-wheel vehicle according to a fifth embodiment of the present invention has substantially the same structure as that of each of the coaxial two-wheel vehicles of the above embodiments, except for the vehicle body structure. Note that a description of the parts common to those of the above embodiments is omitted.

Though the vehicle body of this embodiment has substantially the same structure as that of each of the vehicle bodies of the first to third embodiments, the left and right step plates are respectively provided to the vertical links of the parallel linkage through the variable portions that allow the left and right step plates to be slid in the left-and-right direction of the coaxial two-wheel vehicle. In other words, though the vehicle body of this embodiment includes the variable portions similar to those of the fourth embodiment, the variable portions are actively controlled based on the rotation angle of the vehicle body in the left-and-right direction.

Specifically, in a similar manner as the coaxial two-wheel vehicles of the first to third embodiments, the passenger applies a load to the parallel linkage at a position inside or outside of the line which passes through the ground contact point of one of the wheels and which is in parallel with the vertical links, thereby rotating the vehicle body in the turning direction. The angle detection sensor detects the rotation angle of the vehicle body, and outputs the detection results to the control device. When the footrest portion of the vehicle body is formed at a position inside of the line which passes through the ground contact point of one of the wheels and which is in parallel with the vertical links, in a similar manner as the vehicle body of the first embodiment, the control device controls the drive devices so that the step plate at the inside of the turning direction is allowed to be slid outward of the coaxial two-wheel vehicle. When the footrest portion of the vehicle body is formed at a position outside of the line which passes through the ground contact point of one of the wheels and which is in parallel with the vertical links, in a similar manner as the vehicle body of the second embodiment, the control device controls the drive devices so that the step plate at the outside of the turning direction is allowed to be slid inward of the coaxial two-wheel vehicle. When the footrest portion of the vehicle body is formed on the line which passes through the ground contact point of one of the wheels and which is in parallel with the vertical links in a similar manner as the vehicle body of the third embodiment, the control device controls the drive devices so that the step plate at the inside of the turning direction is allowed to be slid outward of the coaxial two-wheel vehicle and the step plate at the outside of the turning direction is allowed to be slid inward of the coaxial two-wheel vehicle. With this structure, approximately the same load can be applied to the left and right step plates.

Note that regarding the rotation angle of the vehicle body in the left-and-right direction, the rotation angle of the parallel linkage, the rotation angle of each step plate, and the like can be detected by the angle detection sensor.

The vehicle body of this embodiment is structured to be actively controlled, but the structure of the vehicle body is not limited thereto. Alternatively, each variable portion may be composed of a sliding mechanism and a restoring member such as a spring, and the left and right step plates may be passively controlled. Specifically, the step plates are allowed to be slid in the left-and-right direction of the coaxial two-wheel vehicle by the operation of the passenger in place of the drive devices. After the turning operation is finished, the step plates are restored to the original positions by the restoring members.

The coaxial two-wheel vehicles of the first to fifth embodiments each include the support member, but the support member may be omitted. In this case, the structure of the coaxial two-wheel vehicle is simple and excellent in design.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A vehicle body structure which constitutes a coaxial two-wheel vehicle including two wheels coaxially arranged, the vehicle body comprising:
a parallel linkage that includes horizontal links and vertical links and is rotatable in a left-and-right direction of the coaxial two-wheel vehicle; and
step plates respectively provided to upper end portions of the vertical links,
wherein a load of a passenger riding on the left and right step plates acts on the parallel linkage at a position inside or outside of a line which passes through a ground contact point of one of the wheels respectively mounted to the vertical links and which is in parallel with the vertical links.

2. The vehicle body structure according to claim 1, wherein
an area of each of the step plates inside of the line which passes through the ground contact point of one of the wheels and which is in parallel with the vertical links serves as a footrest portion, and
the load of the passenger riding on the footrest portion of each of the left and right step plates acts on the parallel linkage at a position inside or outside of the line which passes through the ground contact point of one of the wheels and which is in parallel with the vertical links.

3. The vehicle body structure according to claim 1, wherein
the step plates respectively project outward from the ground contact points of the wheels, and a projecting portion of each of the step plates serves as a footrest portion, and
the load of the passenger riding on the footrest portion of each of the step plates acts on the parallel linkage at a position inside or outside of the line which passes through the ground contact point of one of the wheels and which is in parallel with the vertical links.

4. The vehicle body structure according to claim 1, wherein the step plates are respectively provided to the vertical links through variable portions that allow the step plates to be slid in the left-and-right direction of the coaxial two-wheel vehicle.

5. The vehicle body structure according to claim 2, wherein the step plates are respectively provided to the vertical links through variable portions that allow the step plates to be slid in the left-and-right direction of the coaxial two-wheel vehicle.

6. The vehicle body structure according to claim 3, wherein the step plates are respectively provided to the vertical links through variable portions that allow the step plates to be slid in the left-and-right direction of the coaxial two-wheel vehicle.

7. The vehicle body structure according to claim 4, wherein the variable portions are actively controlled based on distribution of the load of the passenger to the left and right step plates.

8. The vehicle body structure according to claim 5, wherein the variable portions are actively controlled based on distribution of the load of the passenger to the left and right step plates.

9. The vehicle body structure according to claim 6, wherein the variable portions are actively controlled based on distribution of the load of the passenger to the left and right step plates.

10. The vehicle body structure according to claim 4, wherein the variable portions are actively controlled based on a rotation angle of the vehicle body.

11. The vehicle body structure according to claim 5, wherein the variable portions are actively controlled based on a rotation angle of the vehicle body.

12. The vehicle body structure according to claim 6, wherein the variable portions are actively controlled based on a rotation angle of the vehicle body.

13. A coaxial two-wheel vehicle comprising:
two wheels coaxially arranged; and
a vehicle body structure according to claim 1.
